(19) United States
(12) Patent Application Publication
(10) Pub. No.: US 2012/0307478 A1
(43) Pub. Date: Dec. 6, 2012

(54) ELECTRIC METER WITH BACKLIGHT INDICATOR

(76) Inventor: SHAW-LIN LIU, New Taipei City (TW)

(21) Appl. No.: 13/151,290

(22) Filed: Jun. 2, 2011

(51) Int. Cl. G01D 11/28; G01D 7/02

(52) U.S. Cl. 362/23; 73/866.3

(57) ABSTRACT

The electric meter contains a number of indicator units radially arranged along the circumference of a selection dial and a backlight switch. Each indicator unit contains a lighting element marked with a label. The backlight switch, when engaged, turns on the lighting element of the indicator unit pointed by the selection dial so that its label is visible in the dark and the operation mode of the electric meter is identifiable, even though there is no or little illumination.

### TECHNICAL FIELD OF THE INVENTION

The present invention is generally related to electric meters, and more particularly to an electric meter operable in the dark or in a poorly lit environment.

### DESCRIPTION OF THE PRIOR ART

Currently, an electric meter or a multi-meter is capable of measuring a number of electrical properties such as voltage, current, resistance, etc. Therefore, there is usually a selection dial for choosing a desired measurement function or operation mode of the electric meter.

Around the selection dial, there are markings indicating the various functions or modes available. A function or mode is selected by pointing the selection dial to the corresponding marking. However, when the electric meter is operated under little or no illumination such as when the electricity is shut down or when the measurement has to be conducted in a closed breaker box. The markings on the electric meter cannot be identified and a user may as such select a wrong function or mode. This is not only inconvenient. Furthermore, a wrong selection could even cause damage to the electric meter when, for example, AC current is measured while the electric meter is set to measure DC current.

### SUMMARY OF THE INVENTION

Therefore, a novel electric meter is provided herein which contains a number of indicator units radially arranged along the circumference of a selection dial and a backlight switch. Each indicator unit contains a lighting element marked with a label. The backlight switch, when engaged, turns on the lighting element of the indicator unit pointed by the selection dial so that its label is visible in the dark and the operation mode of the electric meter is identifiable.

The lighting element of each indicator unit could be a light emitting diode or other electronic type of light producing element.

The label could be a text or a graph engraved, printed, or adhered to the surface of each indicator unit.

When the electric meter is put to use in the dark or in a poorly lit environment, the backlight switch is engaged and the lighting element of the indicator unit pointed by the selection dial is turned on while the rest of the lighting elements are turned off. A user therefore could clearly identify the current selected function of the electric meter, even though there is no or little illumination.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an electric meter with backlight indicators according to an embodiment of the present invention.

FIG. 2 is a front-view diagram showing the electric meter with backlight indicators of FIG. 1.

FIG. 3 is a front-view diagram showing the electric meter with backlight indicators of FIG. 1 when its backlight switch is engaged and its selection dial is pointed to an indicator unit labeled with “DVC.”

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

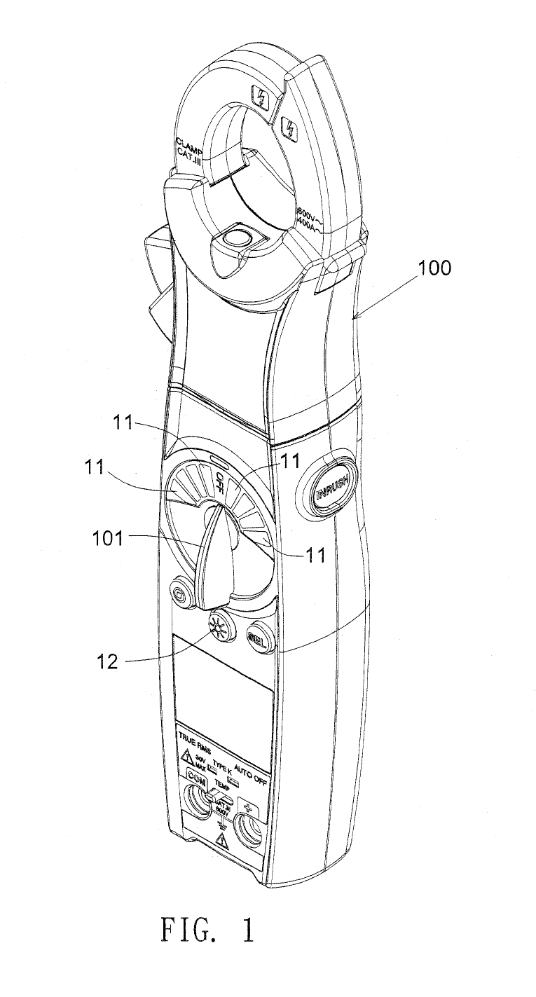

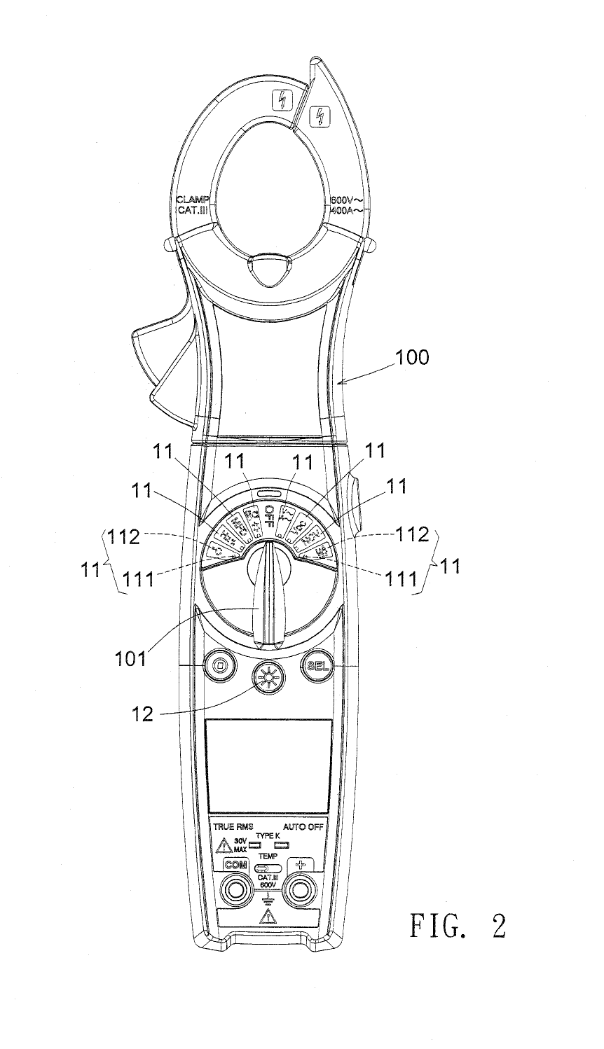

An electric meter 100 according to an embodiment of the present invention, as illustrated in FIGS. 1 to 3, contains a number of indicator units 11 radially arranged along the circumference of a selection dial 101. Each indicator unit 11 contains a lighting element 111 marked with a label 112. The electric meter 100 also contains a backlight switch 12 that, when engaged, the lighting element 111 of the indicator unit 11 pointed by the selection dial 101 is turned on so that the indicator unit 11's label 112 is visible in the dark, clearly indicating the operation mode of the electric meter 100, such as voltmeter, ammeter, etc., selected by the selection dial 101.

The lighting element 111 of each indicator unit 11 could be a light emitting diode or other electronic type of light producing element. The present invention does not pose specific requirement on the lighting elements 111.

The label 112 could be a text or a graph engraved, printed, or adhered to the surface of each indicator unit 11. The present invention does not pose specific requirement on the labels 112.

The backlight switch 12 of the electric meter 100 could be a push button or a toggle. The present invention does not pose specific requirement on the backlight switch 12.

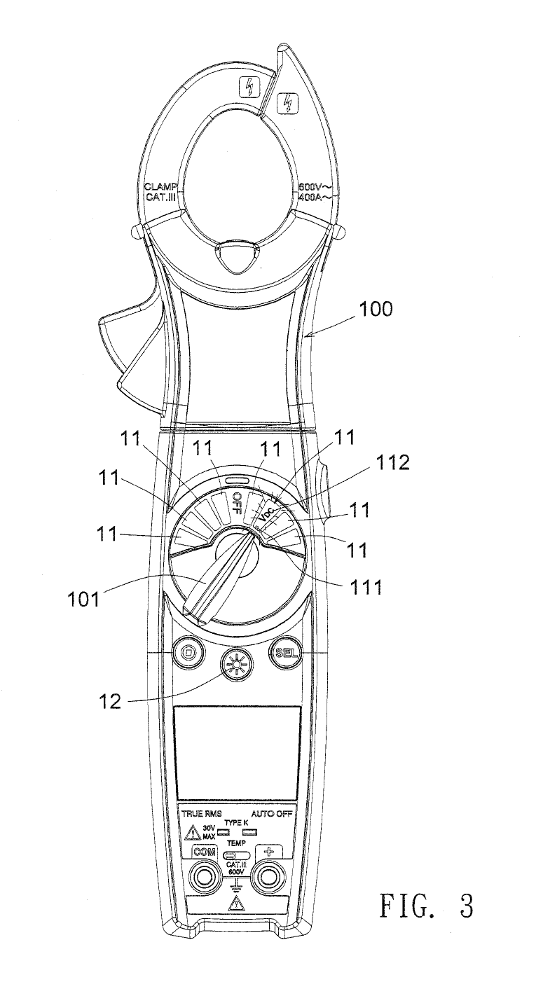

When the electric meter 100 is put to use in the dark or in a poorly lit environment, the backlight switch 12 is engaged and the lighting element 111 of the indicator unit 11 pointed by the selection dial 101 is turned on while the rest of the lighting elements 111 are turned off. For example, as shown in FIG. 3, the selection dial 101 is turned to point to an indicator unit 11 whose label 12 is “DVC” and a user therefore could clearly identify that the electric meter 100 is set to function as the DC voltmeter, even though there is no or little illumination.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electric meter with backlight indicators, comprising:
a plurality of indicator units radially arranged along the circumference of a selection dial of said electric meter, each indicator unit having a lighting element marked with a label; and
a backlight switch that, when engaged, said lighting element of an indicator unit pointed by said selection dial is turned on and said label of said indicator unit is illuminated.

2. The electric meter according to claim 1, wherein each of said labels is a text.

3. The electric meter according to claim 1, wherein each of said labels is a graph.

4. The electric meter according to claim 1, wherein each of said labels includes text and graph.

5. The electric meter according to claim 1, wherein said backlight switch is a push button.

6. The electric meter according to claim 1, wherein said backlight switch is a toggle.
